(19) United States
(12) Patent Application Publication
(10) Pub. No.: US 2006/0060091 A1
(43) Pub. Date: Mar. 23, 2006

(54) Squeezer for squeezing fruit to get pulp

(76) Inventor: Ming-Shih Chang, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 10/946,551

(22) Filed: Sep. 22, 2004

(51) Int. Cl. A23N 1/00

(52) U.S. Cl. 99/511

(57) ABSTRACT

A squeezer for squeezing fruit to get pulp comprises a motor seat having a motor; a rotary disk combined to a spindle of the motor; a middle disk combined to the motor seat; a knife disk screwed to a central screw rod of the rotary disk; a filter mask fixed to the rotary disk through the knife disk; an upper cover combined to the middle disk; a press tube insertable into a central insertion tube of the upper cover; and a knife disk cover installed to a lower side of the insertion tube; a horizontal press plate extending from the knife disk cover; the horizontal press plate having a small gap to the knife disk so that fruits are ground by the knife disk as into pulps and then drained out.

### FIELD OF THE INVENTION

The present invention relates to squeezers, and particular to a squeezer for squeezing fruit to get pulp, wherein when the knife disk cover is assembled to an insertion tube of an upper cover, the gap between the knife disk cover and the horizontal press plate is very small so that the fruit is ground into pulps. When the knife disk cover is detached, the squeezer has the function of squeezing juice.

### BACKGROUND OF THE INVENTION

With reference to FIGS. 1 and 2, the prior art squeezer (10) is illustrated. The squeezer comprises a motor seat (1) having a motor (11); a rotary disk (2) combined to the motor seat (1); a knife disk (4) screwed to a central screw rod (21) of the rotary disk (2) (a knife disk seat (41) is installed below the knife disk (4)); a filter mask (5) fixed to the rotary disk (2) through the knife disk (4); an upper cover (6) combined to the middle disk (3); a press tube (7) insertable into a central insertion tube (61) of the upper cover (6).

With reference to FIG. 3, a whole cross section view of a prior art squeezer is illustrated. It is illustrated that the fruit (8) is placed into the insertion tube and then squeezed along the press tube (7) so that under the high speed grinding of the knife disk (4) which rotates synchronously with the rotary disk (2) so as to grind the fruit into dregs (81) directed tangently into the filter mask (5) and then to be separated juice (82) from the dregs (81) through a slender net structure (51) by the centrifugation of the filter mask (5). The juice (82) flows into the middle disk (3) and then is drained out from the discharging opening (31) to a container (30). The dregs (81) are drained out from the drain groove (63) at a lateral side of the upper cover (6) to be guided into a collecting cylinder (40).

However, above mentioned prior art has no performance of getting pulp. This is because the prior art device has no improved equipment configuration for getting pulp. The pulp contains plentiful fibers which have wide applications, such as coating on a cake, or mixing with vegetables, even as a nutritional supplement of children.

### SUMMARY OF THE INVENTION

Accordingly, the primary object of the present invention is to provide a squeezer for squeezing fruit to get pulp, wherein when the knife disk cover is assembled to an insertion tube of an upper cover, the gap between the knife disk cover and the horizontal press plate is very small so that the fruit is ground into pulp. When the knife disk cover is detached, the squeezer has the function of squeezing juice.

Another object of the present invention is to provide a squeezer for squeezing fruit to get pulp, wherein the filter mask has no slender net structure. The pulp will enter into a middle disk through the filter mask. A V shape cutting means is formed on a top surface of the knife disk so that a center of the knife disk has no dead space in grinding. Furthermore, stopper and switch are used to control the flow of the juice or to seal the flow of the juice.

To achieve above objects, the present invention provides a squeezer for squeezing fruit to get pulp which comprises a motor seat having a motor; a rotary disk combined to a spindle of the motor; a middle disk combined to the motor seat; a knife disk screwed to a central screw rod of the rotary disk; a filter mask fixed to the rotary disk through the knife disk; an upper cover combined to the middle disk; a press tube insertable into a central insertion tube of the upper cover; and a knife disk cover installed to a bottom side of the insertion tube; a horizontal press plate extending from the knife disk cover, the horizontal press plate (corresponding to the knife disk in an up and down relationship) having a small gap to the knife disk so that fruits are ground by the knife disk into pulps and then drained out.

The various objects and advantages of the present invention will be more readily understood from the following detailed description when read in conjunction with the appended drawing.

### BRIEF DESCRIPTION OF THE DRAWINGS

FIG. 1 is an assembled perspective view of a prior art.

FIG. 2 is an exploded perspective view of the prior art.

FIG. 3 is a whole cross section view of the prior art.

FIG. 4 is an exploded view of the first embodiment of the present invention.

FIG. 5 is an assembled view of the first embodiment of the present invention.

FIG. 6 is a schematic view showing the knife disk cover and the knife disk of the present invention.

FIG. 7 is a schematic view showing another kind of the knife disk cover and knife disk of the present invention.

FIG. 8 is an exploded perspective view of the knife disk cover and insertion tube according to the present invention.

FIG. 9 is a whole cross section view of the FIG. 8 after combination.

FIG. 10 is a top plan view of the knife disk of the present invention.

FIG. 11 is a whole cross section view of the squeezer of the present invention.

FIG. 12 is a partial sectional view of the upper cover in the second embodiment of the present invention.

FIG. 13 is an assembled perspective view of the third embodiment of the present invention.

FIG. 14 is a whole cross section view of FIG. 13.

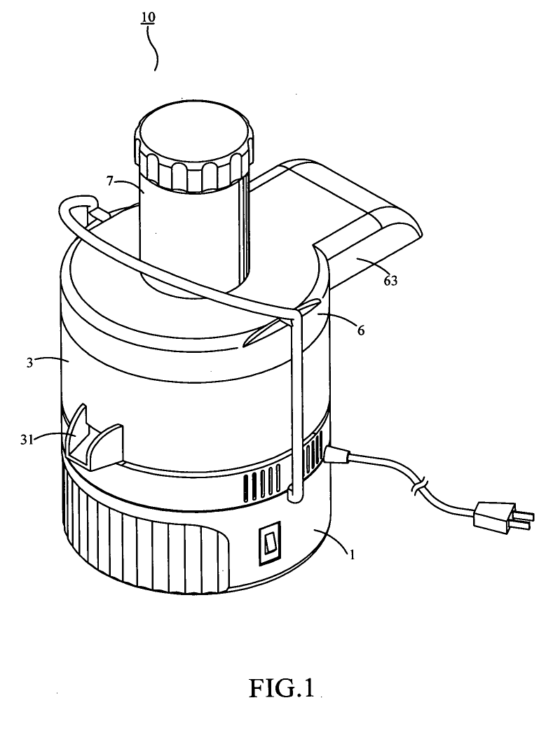

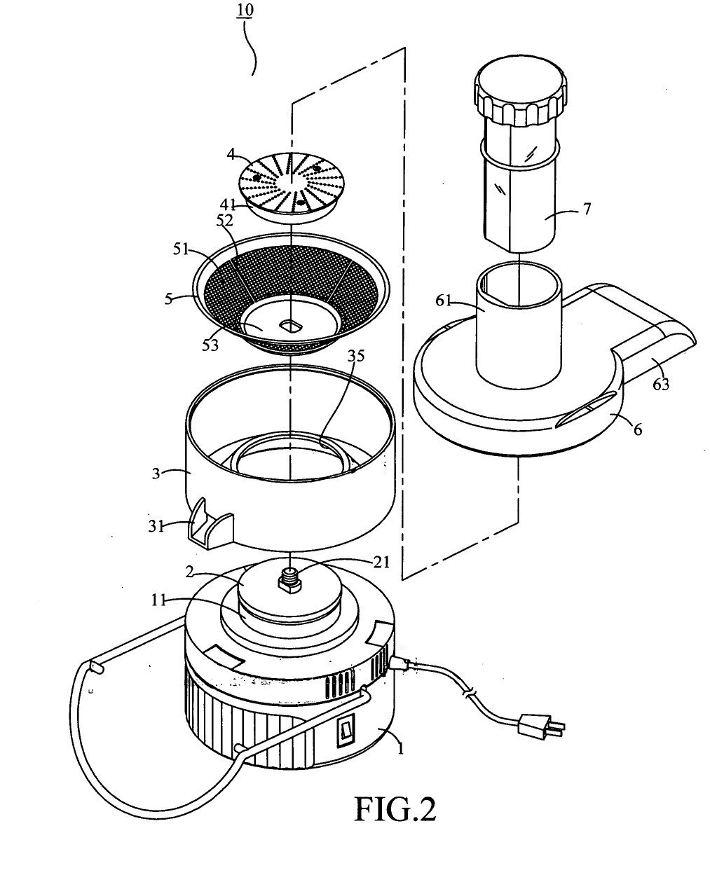

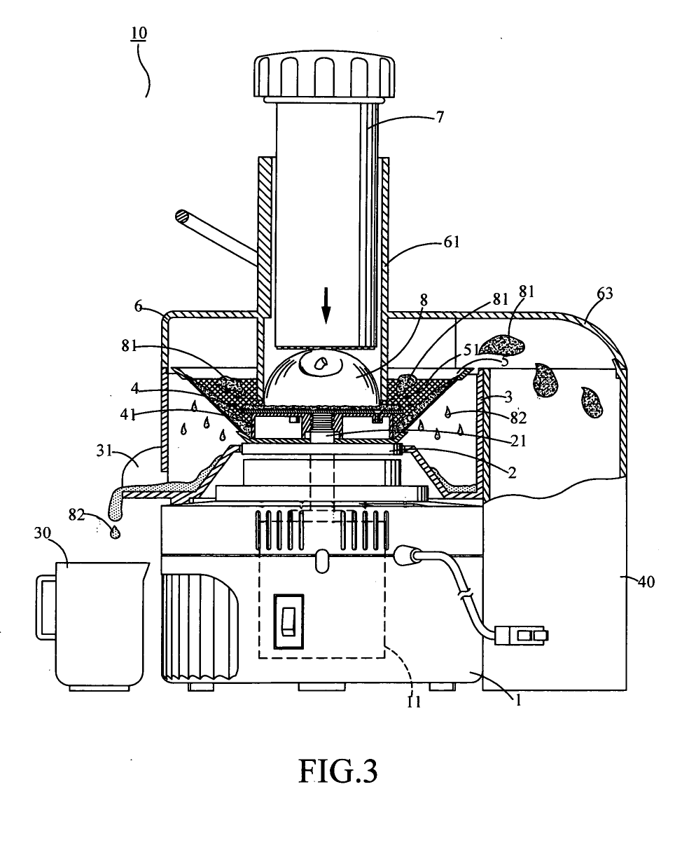

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

### First Embodiment

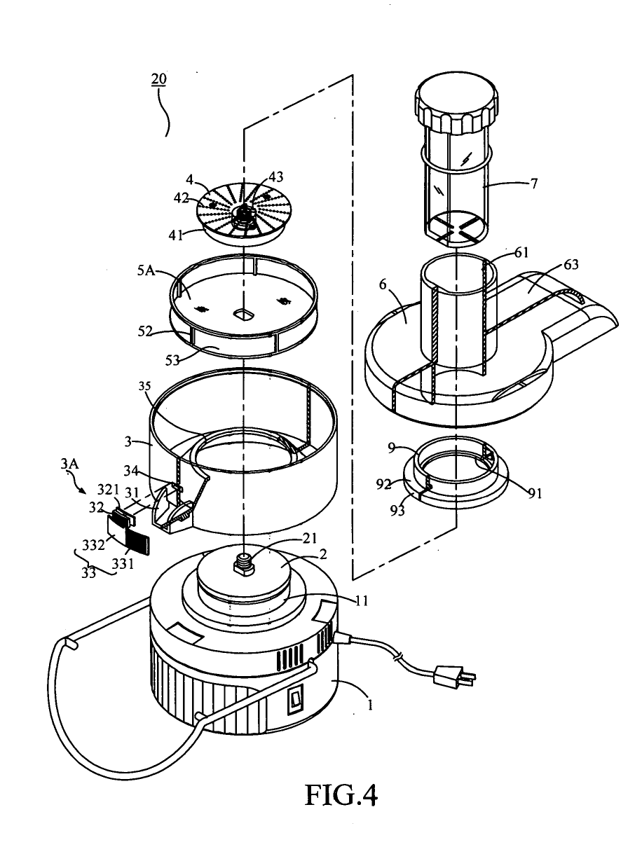

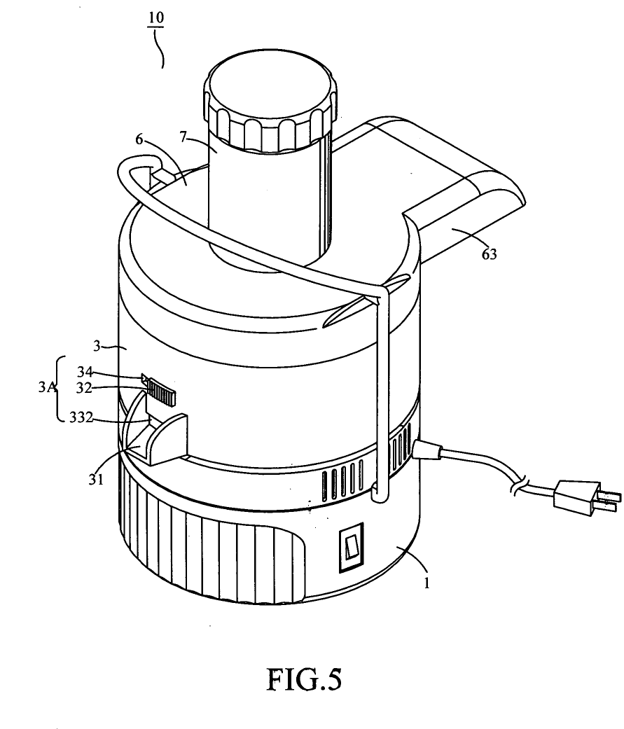

Referring to FIG. 4, an exploded perspective view about the first embodiment of the present invention is illustrated. In the present invention, the pulp squeezer 20 includes a motor seat (1), a rotary disk (2), a middle disk (3), a knife disk (4), a filter mask (5A), an upper cover (6), a press tube (7), and a knife disk cover (9) which is a novel design of the present invention, after combination, see FIG. 5.

In FIG. 5, it is illustrated that drain groove (63) extends from an outer edge of the upper cover (6). However, a pulp squeezer (20) without the drain groove (63) is still within the scope of the present invention. A stopper (3A) is added to the middle disk (3) (which is described in detail in paragraph

However, a pulp squeezer (20) without the stopper (3A) is still within the scope of the present invention.

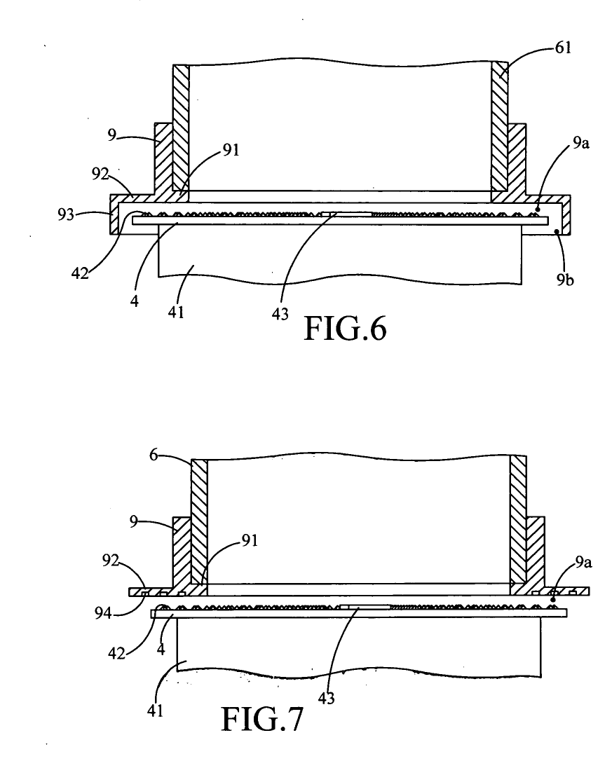

The knife disk cover (9) is combined to the lower side of an insertion tube (61) of the upper cover (6). (Please refer to FIG. 4 again) The way for combining the knife disk cover (9) to the insertion tube (61) is not confined to the present invention. Other ways are permissible in the present invention. In FIG. 6, one combination way is illustrated, where an annular knife disk cover (9) is fitted over an outer edge of a bottom of the insertion tube (61) of the upper cover (6). Thereby, the knife disk cover (9) can be quickly engaged to a lower side of the insertion tube (61). Further, a horizontal press plate (92) bulges out from a lower edge of the knife disk cover (9) corresponding to the knife disk (4) in an up and down relationship. Moreover, it is preferable that an area of the horizontal press plate (92) is equal to or larger than that of the knife disk (4) so that a very small gap (9a) is retained therebetween. Next, a stop wall (93) extends downwards from a periphery of the horizontal press plate (92). A very small gap (9b) is formed between the stop wall (93) and the knife disk (4) so that the ground fruit pulp flows downward along the gap (9b). Thereby, it is stopped by the stop wall (93) so as to prolong grinding fruit into pulp time.

In FIG. 7, it is illustrated that no stop wall (as numeral reference (93) indicated in FIG. 6) is installed on the knife disk cover (9), but a horizontal press plate (92) is used so that fruit is ground between the horizontal press plate (92) and the knife disk (4) to get pulp. Next, a bottom surface of the knife disk cover (9) is formed with a plurality of annular shallow trenches (94) which are arranged along a spiral path or a plurality of circle paths with an equal space. Thereby, the pulp moves outwards successfully.

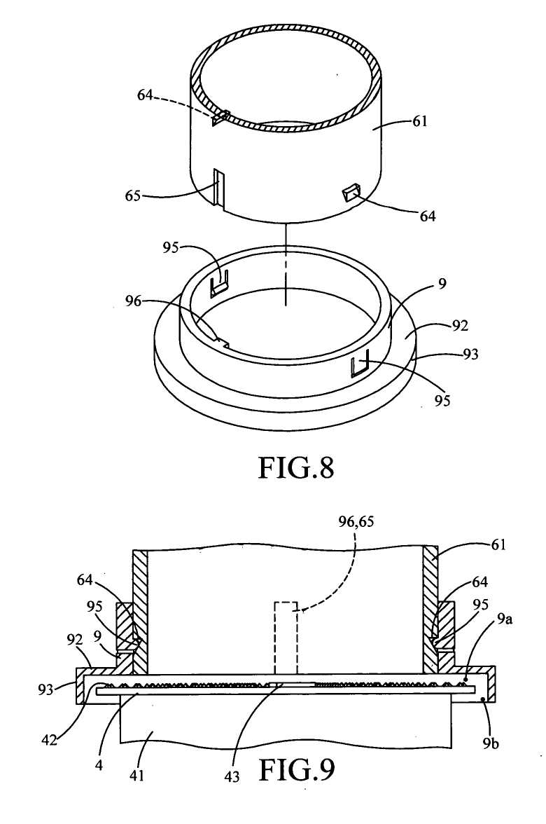

Referring to FIG. 8, another way for combining the knife disk cover (9) and the insertion tube (61) is illustrated. In this way, the knife disk cover (9) is installed with two exposed elastic positioning buttons (95). Positioning grooves (64) are formed along an edge of the insertion tube (61) is corresponding to the positioning buttons (95). Besides, an inner hole of the knife disk cover (9) is installed with a vertical tenon (96). A recess (65) is formed at an inner hole of the insertion tube (61); the recess (65) is corresponding to the vertical tenon (96).

With reference to FIG. 9, the elastic positioning buttons (95) of the knife disk cover (9) are embedded into the positioning grooves (64) at an outer edge of the insertion tube (61) so as to combine the two. Unless using an external force, the knife disk cover (9) will not be separated from the insertion tube (61). After the vertical tenon (96) is inserted into the recesses (65), the knife disk cover (9) is non-rotatable.

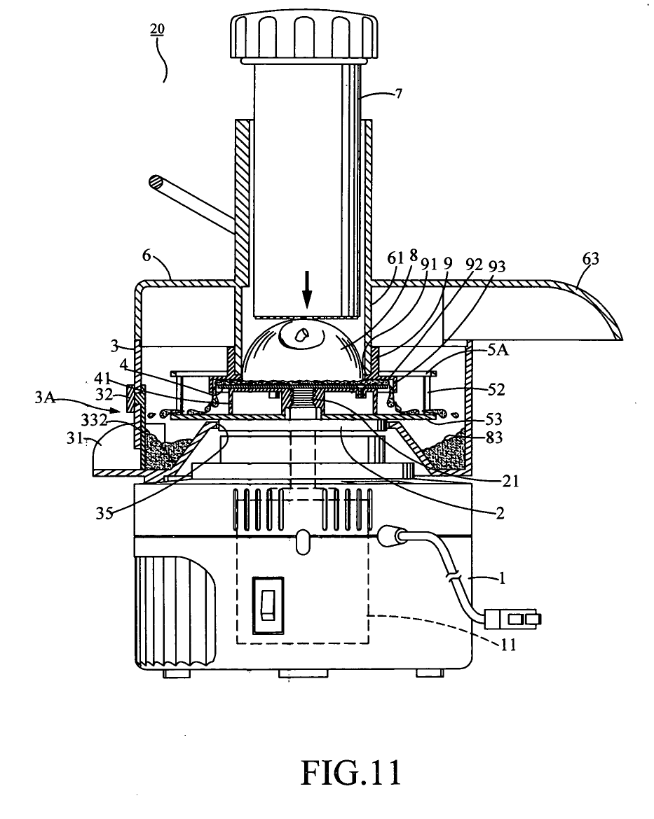

In the present invention, the filter mask (SA), can be used instead of said filter mask (5), includes a net frame (52) and a bottom plate (53) for drain-proof (referring to FIG. 4). In other words, the slender net structure (5 1) is removed. A height of the net frame (52) can be reduced. The function of the bottom plate (53) serves to prevent the pulp or juice from flowing out of a central opening (35) of the middle disk (3). Since the filter mask (5A) has no slender net structure the pulp (referring to FIG. 11) will be directly guided into the middle disk (3) by centrifugation of the filter mask (5A).

Conversely, after detaching the knife disk cover (9) from the bottom of the insertion tube (61), the pulp squeezer (20) will ‘turn back’ to become a juicy squeezer for getting juice. Then the slender net structure (51) is used with the filter mask (5). By the centrifugation of the filter mask (5), the juice is separated from the dregs.

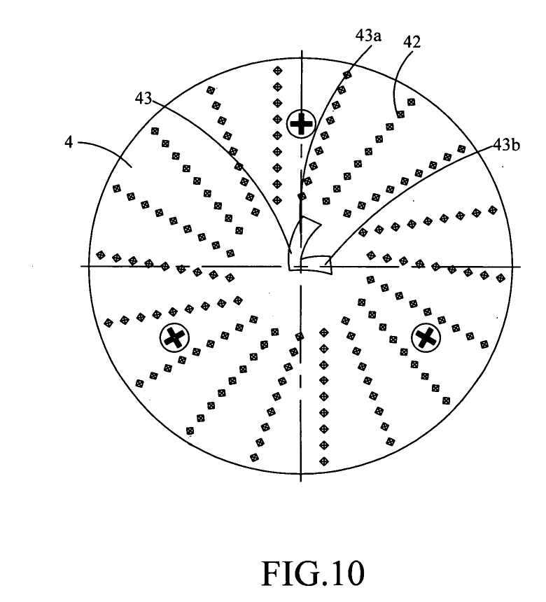

Moreover, referring to FIG. 10, in this example, the knife disk (4) is different from the prior art. A top of the knife disk (4) is installed with a plurality of teeth (42) which are arranged radially as the prior art design. However, in the present invention, a V shape blade (43) is installed at a center thereof. An edge of the V shape blade (43) is cambered. One leg (43a) of the V shape blade (43) is longer than another leg (43b) thereof. The tip of the V shape blade (43) is at a center of the knife disk (4) so as to eliminate the centrally dead space in grinding. The V shape blade (43) serves to cut fibers. The V shape blade (43) is formed by one punching process.

Besides, a stopper (3A) can be installed to a discharging opening of the middle disk (3) for shielding the discharging opening. There are various kinds of stoppers which are within the scope of the present invention. In FIG. 4, the discharging opening of the middle disk (3) has a sliding slot (34) at an upper end thereof. The sliding slot (34) has a push key (32). A rear side of the push key (32) has a seal plate (321). A sliding plate (33) is connected to the lower side of the push plate (321). A net plate (331) is at a right side of the sliding plate (33) and a stop plate (332) is at a left side thereof. When the push key (32) moves leftwards and rightwards, the sliding plate (33) will move. When the net plate (331) stops at the discharging opening (31), the juice will flow out successfully. When the stop plate (332) stops upon the discharging opening (31) (see FIG. 11), the juice (81) or pulp (83) will not flow out. When the middle disk (3) is full of pulp (83), the upper cover (6) is opened for taking out the pulp by scooping. If the stopper is not installed, the juice and pulp can flow out from the discharging opening (31).

### Second Embodiment

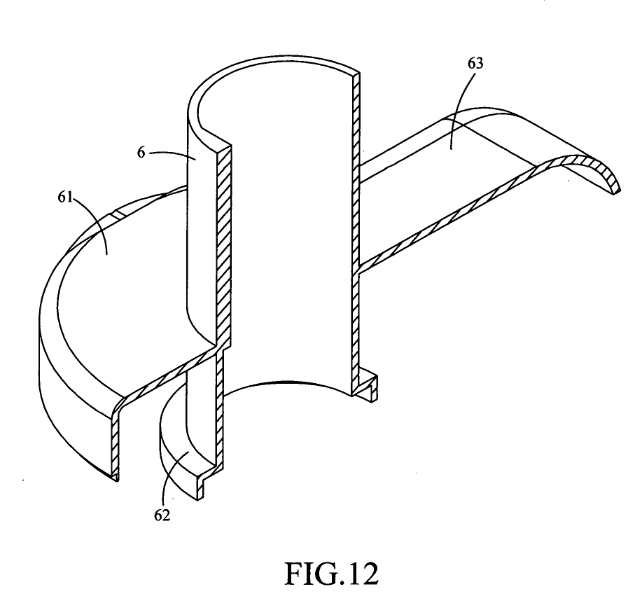

Referring to FIG. 12, the second embodiment of the present invention is illustrated. The structure of the upper cover (6) is illustrated. It is illustrated that a knife disk cover (62) is installed below the insertion tube (61) is identical to that of the knife disk cover (9). The difference of the two is that the combining ways are different. Since the knife disk cover (62) is used in squeezing, to get juice, the conventional filter mask (5) with slender net structure is further used, which can generate a high speed centrifugation so that the fruit dregs are separated from the pulp. Conversely, if it is desired to get pulp, the filter mask (5) is changed as the filter mask (5A) without slender net structure.

### Third Embodiment

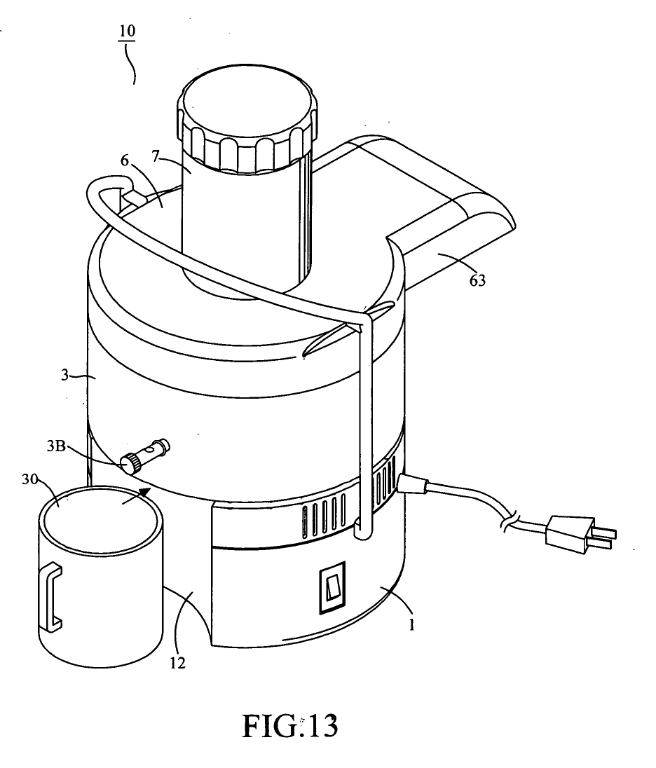

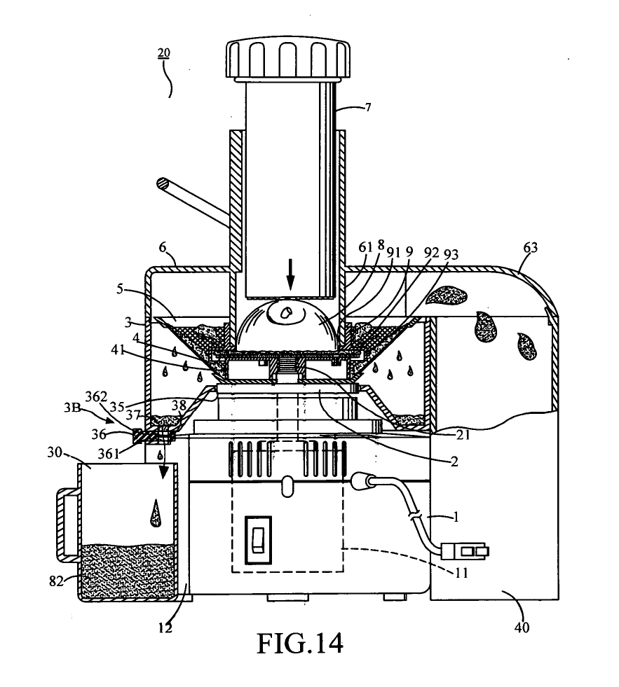

With reference to FIGS. 13 and 14, the assembly view of the squeezer in the third embodiment of the present invention is illustrated. The difference of the present invention from the first embodiment is that an outer edge of the middle disk (3) has no discharging opening, while a cambered recessed groove (12) is formed on a lateral side opposite to the drain groove (63) of the motor seat (1). An outer wall of the middle disk (3) at a lower center above the cambered recessed groove (12) is installed with a button switch (3B) which is formed by inserting a stud (36) into a stud hole of the middle disk (3). Refer to FIG. 14, a clip ring (38) serves to fix the stud (36). Since the stud (36) has the through hole (361) (a filter mask (362) is in the hole) corresponding to the draining hole (37) at a bottom of the middle disk (3), juice passes through the draining hole (37) and then passes out of the through hole (361) to drain out. Conversely, when the stud (36) is rotated through 90 degrees, the through hole (31) will not communicate to the draining hole (37). Thus the juice can not drain out.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A squeezer for squeezing fruit to get pulp comprising:
a motor seat having a motor;
a rotary disk combined to a spindle of the motor;
a middle disk combined to the motor seat;
a knife disk screwed to a central screw rod of the rotary disk;
the filter mask is formed by a supporting filter net frame and a drain-proof bottom plate mounted to the squeezer;
an upper cover combined to the middle disk;
a press tube insertable into a central insertion tube of the upper cover; and
a knife disk cover installed to a bottom side of the insertion tube; a horizontal press plate extending from the knife disk cover, the horizontal press plate having a small gap to the knife disk;
wherein a stop wall downwards and vertically extends from a periphery of the horizontal press plate; a small gap is formed between the stop wall and the knife disk.

2. The squeezer for squeezing fruit to get pulp as claimed in claim 1, wherein a lower edge of the knife disk cover extended inwards with a horizontal stopper for stopping a lower edge of the insertion tube.

3. The squeezer for squeezing fruit to get pulp as claimed in claim 1, wherein the knife disk cover and the insertion tube of the upper cover are integrally formed.

4. The squeezer for squeezing fruit to get pulp as claimed in claim 1, wherein the knife disk cover is installed with two exposed elastic positioning buttons; an edge of the insertion tube is installed with positioning grooves corresponding to the positioning buttons; an inner hole of the knife disk cover is installed with a vertical tenon; an inner hole of the insertion tube is installed with recesses corresponding to the vertical tenon.

5. (canceled)

6. The squeezer for squeezing fruit to get pulp as claimed in claim 1, wherein a central portion of a top of the knife disk has a V shape cutting means; and the V shape blade is formed by two and the connection of the legs at a center of the knife disk.

7. The squeezer for squeezing fruit to get pulp as claimed in claim 1, wherein a stopper is installed to an discharging, opening of the middle disk for shielding the discharging opening, the stopper is formed by a push key which is connected to a sliding plate, the sliding plate includes a net plate and a sealing stop plate.

8. The squeezer for squeezing fruit to get pulp as claimed in claim 1, wherein a cambered recessed groove is formed on a Interal side of the motor seat opposite to the drain groove; an outer wall above the cambered recessed groove at a lower center of the middle disk is installed with a button switch which is formed by inserting a stud into a stud hole of the middle disk; the stud has a through hole corresponding to the draining hole at a bottom of the middle disk.
